(19) United States
(12) Patent Application Publication
(10) Pub. No.: US 2003/0007003 A1
(43) Pub. Date: Jan. 9, 2003

(54) Data processing device with server-generated graphic user interface

(76) Inventors: Dominic Jan Ostrowski, Cambridgeshire (GB); Nicholas Holder Clarey, Cambridge (GB); Richard Thomas Panton, Cambridge (GB)

Correspondence Address: William M. Lee, Jr., Lee, Mann, Smith, McWilliams, Sweeney & Ohlson, P.O. Box 2786, Chicago, IL, 60690-2786, US

(21) Appl. No.: 10/151,200

(22) Filed: May 20, 2002

(30) Foreign Application Priority Data
May 24, 2001 (GB) 0112761.2

(51) Int. Cl. G09G 5/00

(52) U.S. Cl. 345/746

(57) ABSTRACT

Disclosed is a data processing device comprising a microprocessor, a display screen and a memory in which is stored a browser program executable by the microprocessor to request data in a known data format from a server program, to interpret and render the data and generate therefrom signals suitable for display in the display screen, wherein a graphic user interface is stored in the memory in the known data format, together with a local server program, which is executable by the microprocessor to transmit data, including the graphic user interface, in the known data format from the memory to the browser program in response to requests from the browser program

### FIELD OF THE INVENTION

This invention relates to data processing devices that display a graphic user interface (GUI), and to a method of generating a GUI.

### BACKGROUND TO THE INVENTION

Data processing devices that execute a browser program, the browser program being operable to request data from a remote data processing device and to display said data, are of course well known. It is also known for such data processing devices to execute a server program, the server program being operable to transmit data on request to a remote data processing device.

The inventor has appreciated that in a device that executes both a browser program and a server program and displays a GUI, there are several benefits that attach to generating the GUI by means of the server program.

At present, in portable data processing devices such as a personal digital assistant (PDA) or mobile telephone, the program that generates the GUI forms part of an operating system that controls some or all of the other functions of the device, such as audio input and output and communication with other devices. The program that implements the operating system is commonly stored in a read-only memory and is therefore difficult and expensive to modify. Even if the program is stored in a volatile memory, it is often written in an obscure programming language, or the program that generates the GUI may interact with the programs that control other functions of the device, such that modification of the program that generates the GUI requires an overall understanding of the device rather than just the graphic user interface.

The most recent devices have used components or architectures designed for personal computers, which can exploit standard personal computer graphics languages, drivers and displays. Nevertheless, the data processing programs of these devices are still written in obscure programming languages, and the use of components specified for personal computers means that the devices are unnecessarily expensive to manufacture and consume more power than is desirable, particularly in portable devices such as PDAs and mobile telephones.

### SUMMARY OF THE INVENTION

According to the first aspect of the invention there is provided a data processing device comprising at least one microprocessor, a display screen for displaying data including a graphic user interface and memory means in which is stored a browser program operable to request data in a known data format, including the graphic user interface, from a server program, to interpret and render said data and generate therefrom signals suitable for display in the display screen; characterised in that the graphic user interface is stored in the memory means in the known data format, and a server program operable on request to transmit data including the graphic user interface in the known data format from the memory means to the browser program is stored in the memory means.

Preferably the data processing device further comprises data input and output means operable to transmit data in the known data format to, or receive data in the known data format from, a server program stored on a remote data processing device (hereinafter referred to as a remote server). The browser program is operable to transmit a request for data in the known data format to the data input and output means, which is operable to transmit the request to a remote server. Data in the known format received by the data input and output means from the remote server in response to the request is transmitted to the server program (hereinafter referred to as the local server) stored in the memory means of the data processing device. The local server is further operable to transmit data in the known data format to the data input and output means, which is operable to transmit the data to a remote server.

Preferably the known data format is a mark-up language, which may advantageously be hypertext mark-up language (HTML), compact HTML (cHTML), extensible mark-up language (XML) or wireless mark-up language (WML).

The invention therefore provides a data processing device that has a graphic user interface that is easy to modify, being written in HTML and stored in the memory means as a website. The website comprises a plurality of files and mark-up language generating programs that can be replaced or modified by data transmitted to the device by a remote server.

This modification of the user interface can include updating features (such as icons, menu items, background colours and sounds) on a daily basis, or in response to user request or to suit special entertainment events (such as the Olympics).

The browser program and local server are preferably each executed by a separate microprocessor, which results in a relatively high speed of execution.

The transmission path between the microprocessors may advantageously comprise a serial link that employs the transmission control protocol/internet protocol (TCP/IP).

Alternatively, the browser program and local server may advantageously be executed by a single microprocessor, which reduces the speed of execution of the programs but also reduces the number of components in the data processing device and hence reduces the cost and size of the data processing device.

Preferably the data processing device comprises a single unit. It is, however, envisaged that the data processing device may consist of two or more units for the purpose of style, flexibility and/or user convenience.

The local server preferably transmits data in the known data format, for example HTML, to the data input and output means, and the data input and output means preferably transmits data in HTML to a remote server, using the TCP/IP. Thus transmission of data to the data processing device from a remote data processing device and vice versa may conveniently be carried out by means of the internet.

The invention therefore enables a domestic appliance such as a refrigerator or video cassette recorder (VCR) to transmit data to a remote data processing device via the internet and vice versa. By way of example, the refrigerator might be programmed to transmit a shopping list to an online retailer, or a personal digital assistant (PDA) incorporating the invention could be used to remotely program the VCR. Similarly, data stored in the memory of a PDA incorporating the invention, for example the owner's address database, can conveniently be transmitted to another PDA.

Preferably the data processing device comprises a further data input and output means to which a peripheral device may be attached, the peripheral device being operable to generate data and transmit said data to the data processing device. Such a peripheral device might be a video camera or a transducer forming part of a control system. The data transmitted to the data processing device is stored in the memory means and may be converted by the local server into the known data format for transmission to the browser program, to another device or to the internet.

The further data input and output means may advantageously comprise a serial port. Alternatively the further data input and output means may advantageously comprise a parallel port.

The data processing device may advantageously process data received from a peripheral device before transmitting the data to another device or to the internet (hereinafter referred to as pre-processing). In the example of the video camera given above, the pre-processing might comprise compression of the signals from the video camera using a compression program stored in the memory means, in order to reduce transmission time and/or bandwidth requirements.

Alternatively, or additionally, the pre-processing might be carried out on the signals by an image processing program stored in the memory means and operable to detect, by correllation with a template, whether, for example, a particular person is within the field of view of the video camera, or whether a change in the signal from the camera exceeds a preset threshold value, for example a change in the signal from the camera corresponding to movement of an object in the field of view of the camera. Detection of such a condition by the image processing program can be used to trigger one or more of the following actions by the device: storing the video image or a part thereof in the memory means, transmitting the stored image to another device or to the internet, or transmitting a message to another device or to the internet.

Alternatively, the device may be used to control a second device or network of devices in accordance with signals received from transducers associated with the device or network of devices. A control algorithm executed by a program stored in the memory means would carry out control actions in response to the signals from the transducers exceeding or falling below preset values. The network of devices may advantageously comprise domestic appliances such as heaters, lights, or a security system.

The data compression program or image processing program may be stored in the memory means in the form of machine code or a scripting language such as Javascript, or a virtual machine format such as Java byte code, or as a ready to compile program or as an interpretable program.

The transmission path between the device and the network of devices may be wired or wireless, and if wireless may employ any of a number of protocols or proprietary systems such as Bluetooth or wireless Ethernet.

Data stored in the memory means, which may have been generated by the data processing device or transmitted to the device by a remote device can be processed by the device. In addition, the data processing device is advantageously operable to transmit data stored in the memory means to a remote device at which the data is processed and the processed data transmitted to the device.

Moreover, since the user interface is easy to update or modify with data transmitted to the device from another device or from the internet, a particular part of the interface may be periodically updated, for example with news information, such that a user of the device can obtain current news information at any time through the user interface.

According to the second aspect of the invention there is provided a method of displaying a graphic user interface in a display screen of a data processing device having browser and server means, the method comprising the steps of storing the data comprising the graphic user interface in a memory in a known data format, transmitting the data to the server means, transmitting the data in the known data format to the browser means in response to a request from the browser means, the browser means interpreting and rendering the data and generating signals suitable for display in the display screen.

Preferably the known data format is HTML and the graphic user interface is stored in the memory as a website.

### DRAWINGS

Two embodiments of the present invention as applied to a personal digital assistant will now be described, by way of example only, with reference to the accompanying illustrative drawings and source code, in which:

FIG. 1 illustrates the physical architecture of a first data processing device;

FIG. 2 illustrates the graphic user interface during execution of a telephone dialling application;

FIG. 3 shows the source code in HTML and PERL for the telephone dialling application;

FIG. 4 illustrates the physical architecture of a second data processing device including the communication channel from the server and browser programs to remote data processing devices.

### DETAILED DESCRIPTION OF DRAWINGS

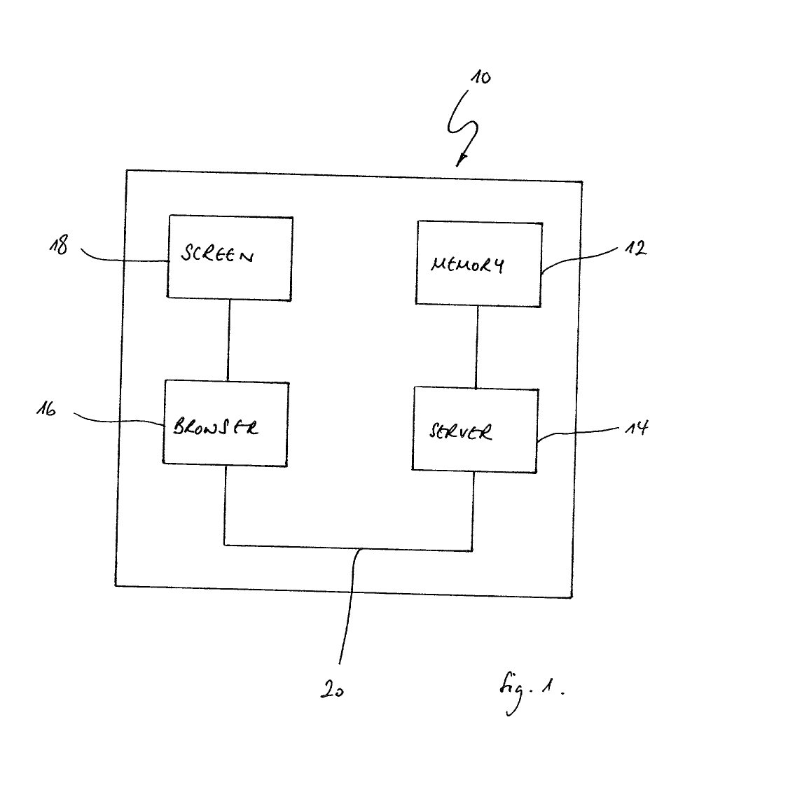

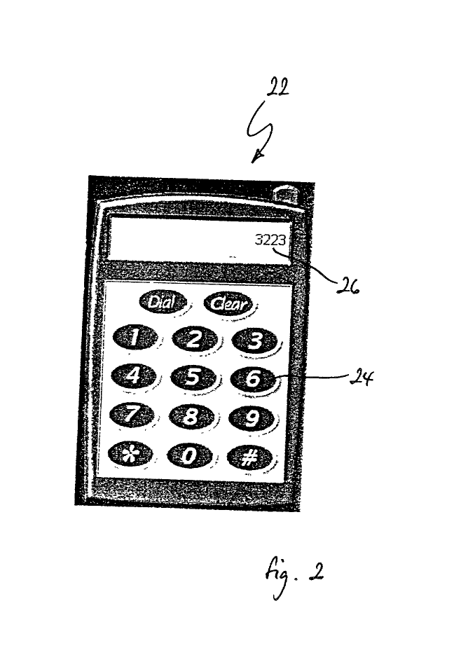

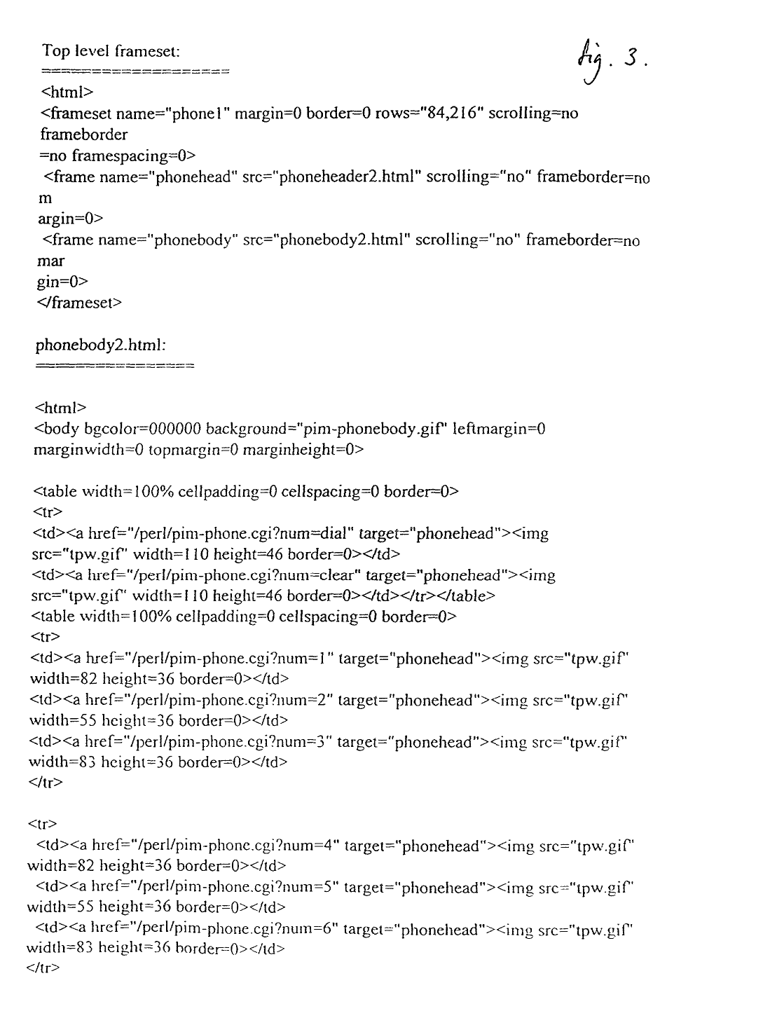

The data processing device of FIG. 1, shown generally by 10, comprises a memory 12, a microprocessor 14 that runs a server program (the server), a microprocessor 16 that runs a browser program (the browser) and a display screen 18. The server program is based on Web Server, a so-called microserver produced by Go Ahead, and the browser program is based on ViewML, a so-called microbrowser produced by Century Software, both of the United States of America.

The graphic user interface (GUI) is stored in the memory 12 in the form of HTML pages, which can contain text and graphics and can also contain opportunities for user interaction with the GUI. User interaction includes such actions as pressing a button to select an item or setting from a list or move to a new screen of information or commands, entering a string of text and/or numerals, or pressing an “OK” button to initiate an action. The data processing intelligence that enables the user to interact with the GUI is implemented in Practical Extraction and Report Language (PERL).

The server microprocessor 14 and browser microprocessor 16 are linked by a serial link 20 that uses the TCP/IP to transmit requests for data from the browser to the server and to transmit HTML pages from the server to the browser in response to said requests. The browser interprets and renders the HTML pages and displays them on the display screen 18. A user of the device is able to modify the GUI by selecting items and/or settings or entering text to, for example, alter the area of the display screen occupied by elements of the GUI or customise text or graphics that appear in the GUI, such as entries in an address book application. The user's selections are transmitted by the browser to the server via the serial link. The server updates the relevant HTML page or pages in accordance with the user's selections and transmits the updated page to the browser, which displays the updated page.

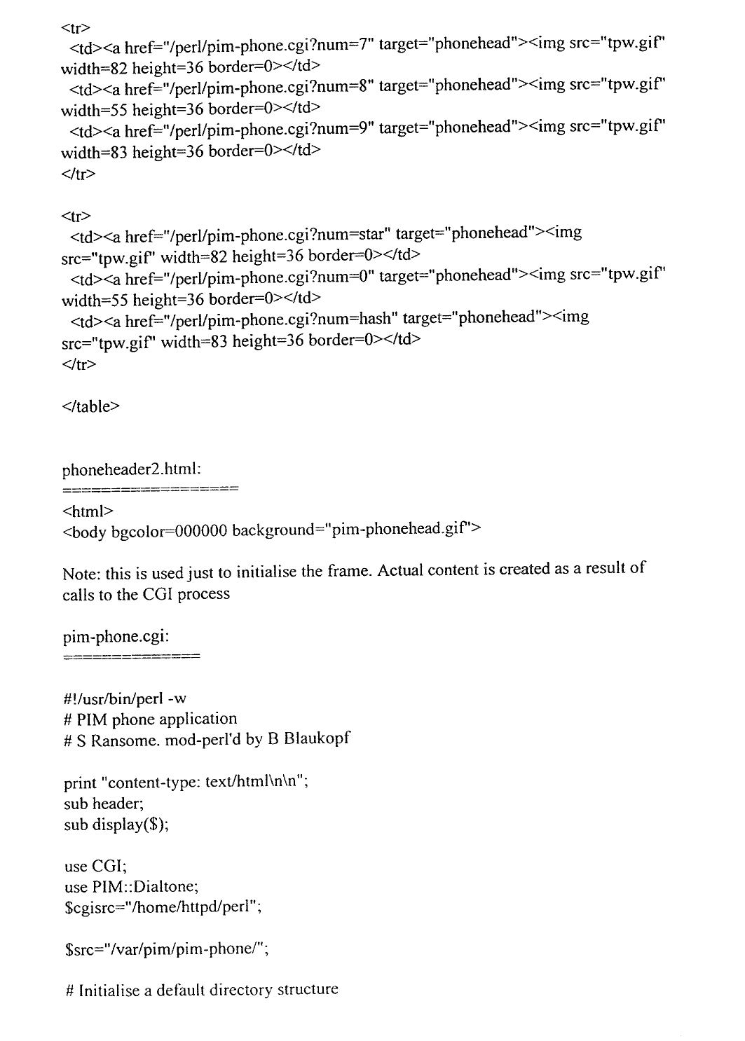

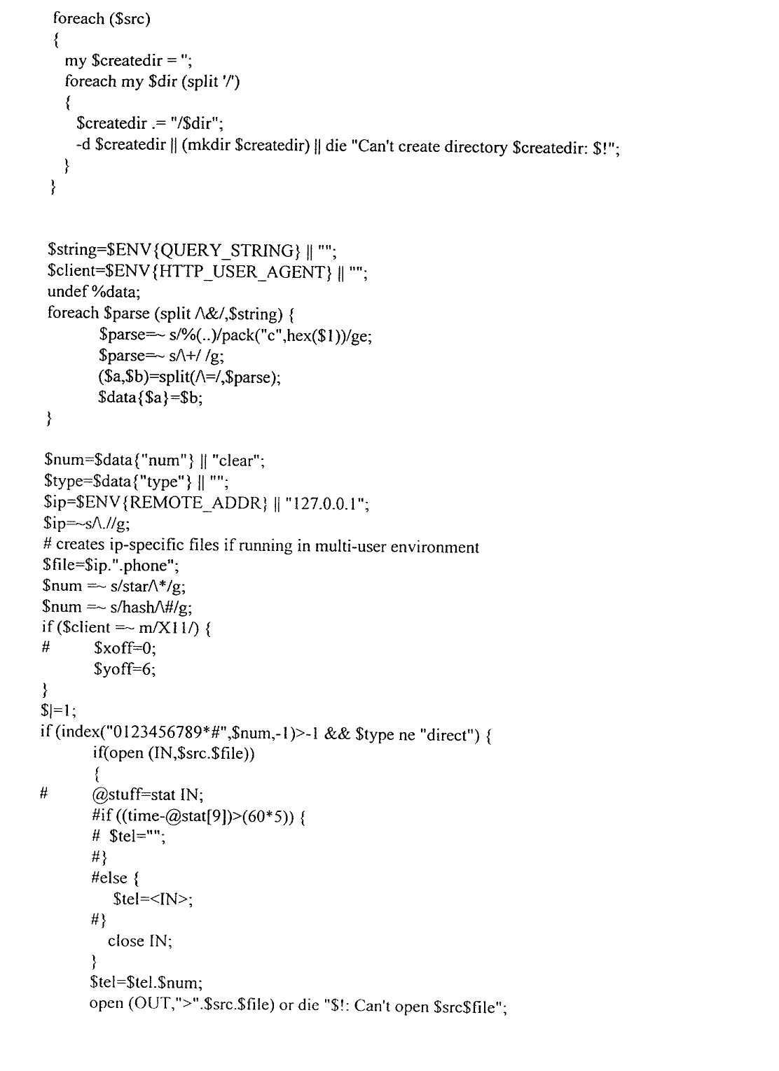

An illustrative GUI of a telephone dialling application is shown generally by 22 in FIG. 2. The user selects the buttons 24 on the screen to enter the telephone number. The PERL script interprets each button press and causes the browser to transmit a request for data, corresponding to each digit of the telephone number, to the server. On receiving each request for data the server adds the digit to the string of previously selected digits (if any) and transmits the graphic data corresponding to that digit or string of digits to the browser, which displays the updated graphic data in the number box 26.

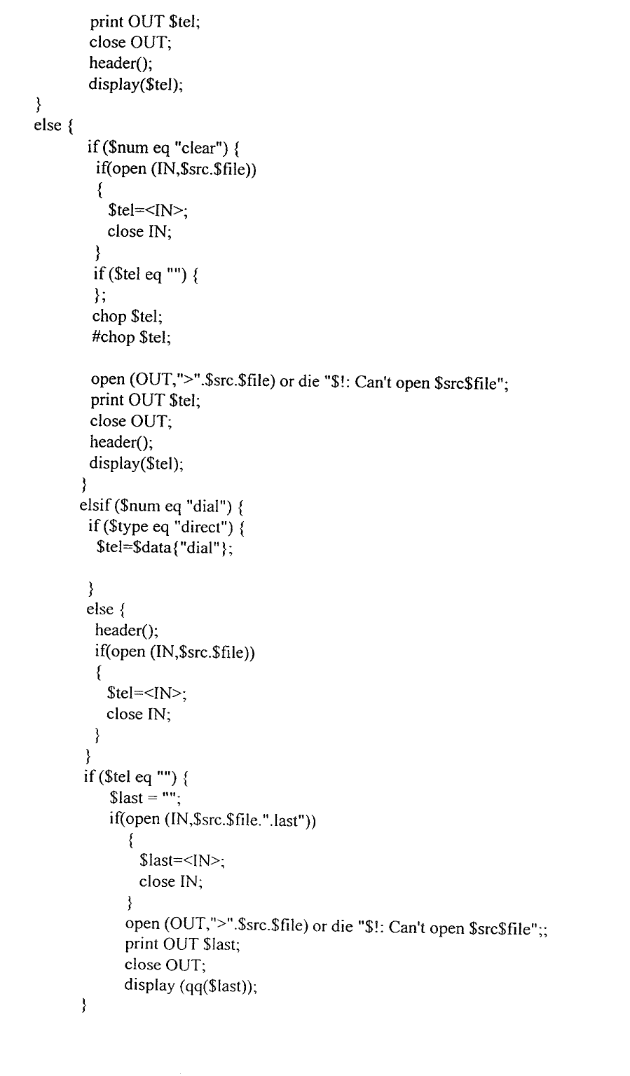

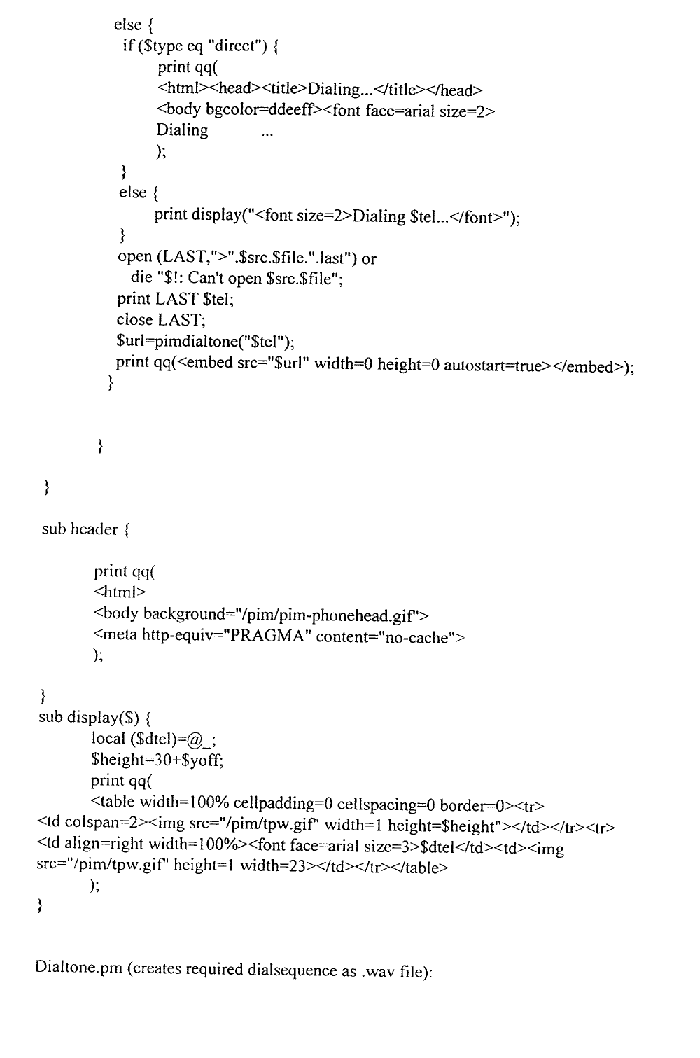

The HTML and PERL script for the telephone dialling application is shown in FIG. 3.

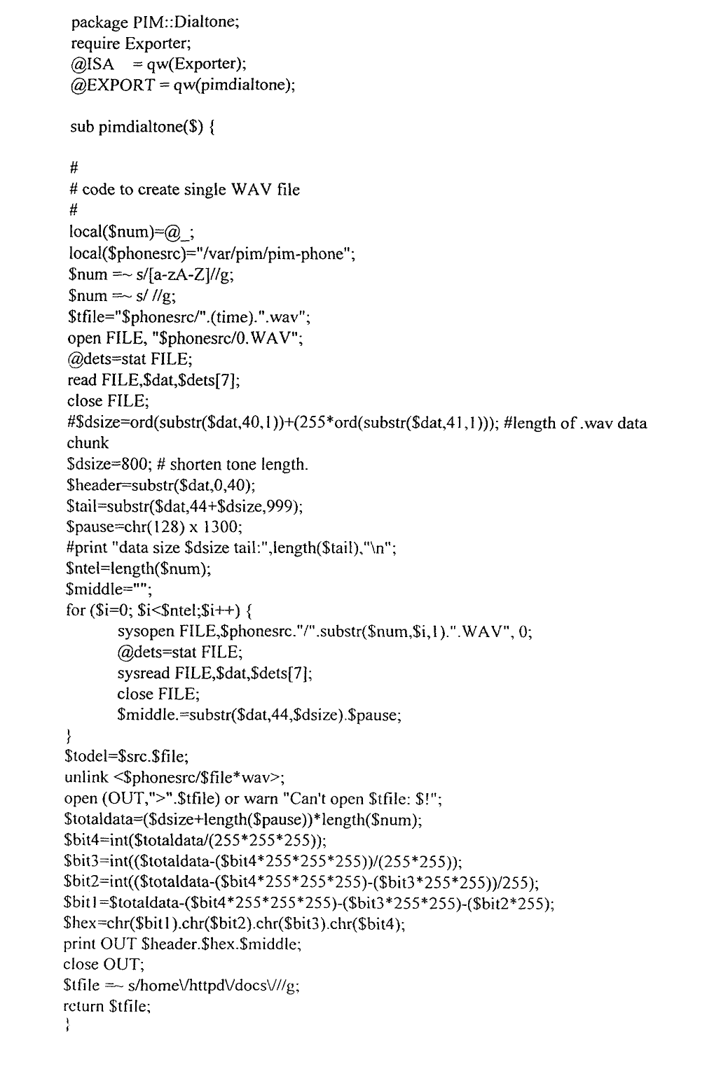

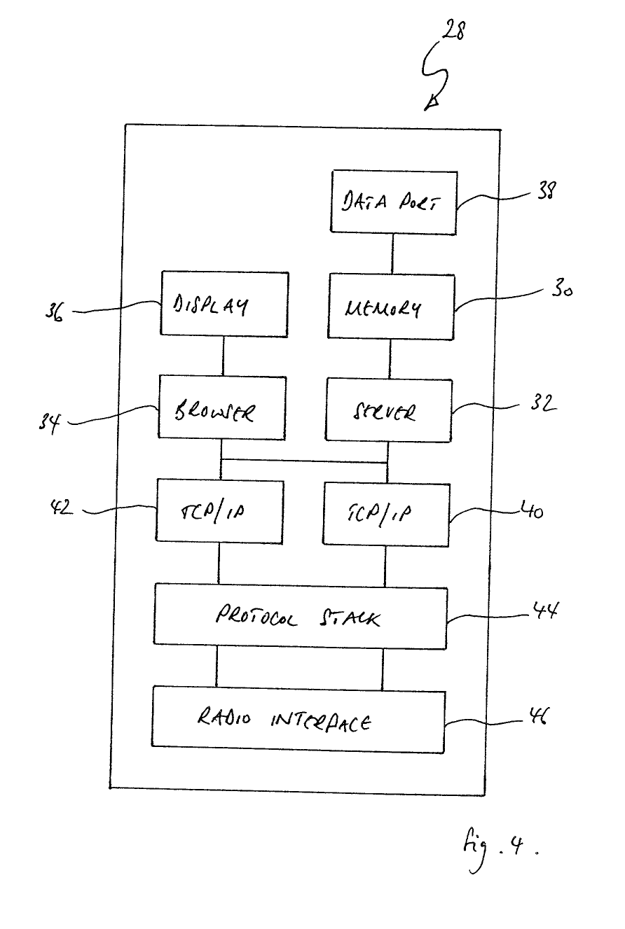

The data processing device of FIG. 4, shown generally by 28, is broadly similar to that shown in FIG. 1, comprising a memory 30, a microprocessor 32 that runs a server program (the server), a microprocessor 34 that runs a browser program (the browser) and a display screen 36. The server and browser programs are modified versions of Web Server and ViewML respectively.

The device further comprises a data port 38, server side and browser side TCP/IP encoders and decoders 40 and 42 respectively, a protocol stack 44 and a radio interface 46. TCP/IP encoders and decoders, protocol stacks and radio interfaces are familiar to, and widely understood by, those in the field of telecommunications.

The GUI may be modified by any remote data processing device with a suitable radio interface, protocol stack and TCP/IP encoder and decoder. Such remote data processing devices include personal computers that have an internet connection and personal digital assistants and mobile telephones capable of internet access. HTML data transmitted to the device by a remote device updates or replaces the existing HTML pages in the memory 30 and the GUI is modified accordingly.

The device is itself able to browse the internet by means of the radio interface 46. In response to a uniform resource locator (URL) entered by a user into the GUI, the browser transmits a request to a remote device, typically an internet server, via the radio interface. In response the remote device transmits the HTML data specified by the URL to the browser. The server microprocessor 32 and a remote device with which the device communicates via the radio interface appear identical to the browser microprocessor 34. The display of the GUI, and applications that form part of the GUI such as the above telephone dialler application, and, for example, internet access, are therefore modeless. This is in contrast with existing devices such as PDAs and mobile telephones, which have distinct local application modes and internet access modes.

The operation of the data port 38 will now be described in relation to a surveillance application. The data port is a serial port adapted to transmit control signals to, and receive video data from, a digital camera (not shown). The data port is linked to the memory 30, which has a large area of volatile memory. Video data received by the serial port is stored in the memory. The server microprocessor 32 is a digital signal processor that is programmed to correlate the video data from the camera with a template in order to determine whether a particular person is in the field of view of the camera. The template, which may have been transmitted to the device by a remote device, is stored in the memory.

The server program is also run by the microprocessor. Although the use of a digital signal processor to execute the server program slows the operation of the server program, this is compensated for by the increase in speed when executing correlation and other typical digital signal processing operations.

The server is programmed to initialise a communication channel with a remote device if it is determined that a particular person is in the field of view of the camera. An alarm signal is transmitted over the communication channel, in response to which the user of the remote device can transmit commands to the device. Such commands include a command for the server to start transmitting the video data to the remote device, to enable the user of the remote device to confirm that the person in question has been correctly identified. The user of the remote device can also send commands to the server to, for example, pan or zoom the digital camera, or for the camera to start recording the video data. These commands are transmitted by the server to the data port and thence to the digital camera.

It will be appreciated that further modifications can be made to the devices described above, and to the ways in which they function, without departing from the scope of the invention.

1. A data processing device comprising at least one microprocessor, a display screen for displaying data, and memory means in which is stored a browser program executable by the at least one microprocessor to request data in a known data format from a server program, to interpret and render the data and generate therefrom signals suitable for display in the display screen; characterised in that a graphic user interface (GUI) is stored in the memory means in the known data format, together with a local server program, which is executable by the at least one microprocessor to transmit data, which data includes the GUI, in the known data format from the memory means to the browser program in response to requests from the browser program.

2. A device according to claim 1, further comprising data input and output means operable respectively to transmit and receive data in the known data format to and from a remote server program stored in a remote data processing device, the browser program being further executable by the at least one microprocessor to transmit a request for data in the known data format to the data input and output means, which is operable to transmit the request to the remote server program, and to transmit data in the known data format received from the remote server program to the local server program.

3. A device according to claim 2, wherein the local server program is further executable by the at least one microprocessor to transmit data in the known data format to the data input and output means, the data input and output means being operable to transmit the data to the remote server program.

4. A device according to any preceding claim, wherein the known data format is a mark-up language.

5. A device according to claim 4, wherein the mark-up language is hypertext mark-up language (HTML).

6. A device according to claim 4, wherein the mark-up language is compact hypertext mark-up language (cHTML).

7. A device according to claim 4, wherein the mark-up language is extensible mark-up language (XML).

8. A device according to claim 4, wherein the mark-up language is wireless mark-up language (WML).

9. A device according to any preceding claim, comprising a first microprocessor operable to execute the browser program and a second microprocessor operable to execute the local server program.

10. A device according to claim 9, further comprising a serial link between the first and second microprocessors.

11. A device according to claim 10, wherein the serial link employs the transmission control protocol/internet protocol (TCP/IP).

12. A device according to any of claims 1 to 8, comprising a single microprocessor operable to execute both the browser and local server programs.

13. A device according to any preceding claim, wherein the at least one microprocessor, display screen and memory means are housed in a single unit.

14. A device according to any of claims 1 to 12, wherein the at least one microprocessor, display screen and memory means are housed in a plurality of units.

15. A device according to any of claims 2 to 14, wherein the data input and output means is operable to transmit data to the remote server program in HTML.

16. A device according to claim 15, wherein the data input and output means is operable to transmit data to the remote server program using the TCP/IP.

17. A device according to claim 2 or any claim dependent therefrom, comprising further data input and output means adapted for attachment to a peripheral device, the peripheral device being operable to generate data and transmit the data to the device.

18. A device according to claim 17, wherein the further data input and output means is adapted for attachment to a video camera.

19. A device according to claim 17, wherein the further data input and output means is adapted for attachment to one or more transducers forming part of a control system.

20. A device according to any of claims 17 to 19, wherein the further data input and output means is operable to transmit data received from a peripheral device to the memory means and the local server program is further executable by the at least one microprocessor to convert the data in the memory means into the known data format for transmission to the browser program or to another data processing device.

21. A device according to any of claims 17 to 20, wherein the further data input and output means comprises a serial port.

22. A device according to any of claims 17 to 20, wherein the further data input and output means comprises a parallel port.

23. A device according to any of claims 17 to 22, wherein the at least one microprocessor is operable to process data received from a peripheral device before transmitting the data to another data processing device.

24. A device according to claim 23 when dependent from claim 18, wherein a data compression program is stored in the memory means, executable by the at least one microprocessor to compress data received from a video camera.

25. A device according to either of claims 23 and 24 when dependent from claim 18, wherein an image processing program is stored in the memory means, executable by the at least one microprocessor to detect, by correllation of data received from a video camera with a template, whether a particular person is within the field of view of the camera.

26. A device according to any of claims 23 to 25 when dependent from claim 18, wherein an image processing program is stored in the memory means, executable by the at least one microprocessor to detect whether an object in the field of view of a camera is moving, by determining whether a change in data from the video camera exceeds a preset threshold value.

27. A device according to any of claims 24 to 26, wherein the data compression program or image processing program is stored in the memory means as machine code.

28. A device according to any of claims 24 to 26, wherein the data compression program or image processing program is stored in the memory means as a scripting language.

29. A device according to claim 28, wherein the scripting language is Javascript.

30. A device according to any of claims 24 to 26, wherein the data compression program or image processing program is stored in the memory means as a virtual machine format.

31. A device according to claim 30, wherein the virtual machine format is Java byte code.

32. A device according to any of claims 24 to 26, wherein the data compression program or image processing program is stored in the memory means as a ready to compile program.

33. A device according to any of claims 24 to 26, wherein the data compression program or image processing program is stored in the memory means as an interpretable program.

34. A device according to either of claims 25 and 26, or any claim dependant therefrom, operable upon detection whether a particular person is within the field of view of the camera or whether an object in the field of view of the camera is moving to carry out one or more of the following actions:
storing an image or part thereof from the camera in the memory means;
transmitting said image to another device; or
transmitting a message to another device.

35. A device according to any of claims 17 to 34, wherein the further data input and output means is operable to transmit control signals to one or more peripheral devices and to receive signals from one or more transducers associated with each peripheral device, a control program is stored in the memory means and is executable by the at least one microprocessor to generate control signals for transmission to the one or more peripheral devices in response to the signals form the transducers exceeding or falling below predetermined values.

36. A device according to claim 35, wherein the one or more peripheral devices includes a domestic appliance.

37. A device according to any of claims 34 to 36, wherein the further input and output means comprises a wireless transceiver.

38. A device according to claim 37, wherein the wireless transceiver is adapted to operate in accordance with the Bluetooth protocol.

39. A device according to claim 37, wherein the wireless transceiver is adapted to operate in accordance with the wireless Ethernet protocol.

40. A device according to any of claims 23 to 39, further operable to transmit data stored in the memory means to another data processing device at which the data is processed, and to received processed data transmitted by said other data processing device.

41. A device according to any of claims 2 to 40, operable to receive data corresponding to the GUI or a part thereof transmitted by another device, and to modify the GUI or part thereof in accordance with said data.

42. A method of generating a GUI for display in a display screen of a data processing device having browser and server means, the method comprising the steps of:
storing data comprising the GUI in a memory in a known data format;
transmitting the data to the server means;
transmitting the data in the known data format to the browser means in response to a request from the browser means; and
interpreting and rendering the data and generating signals suitable for display in the display screen using the browser means.

43. A method according to claim 42, wherein the known data format is HTML.

44. A method according to claim 42 or 43, wherein the GUI is stored in the memory means as a website.

45. A data processing device substantially as hereinbefore described and with reference to the accompanying drawing FIGS. 1 and 4.
